(19) United States
(12) Patent Application Publication
(10) Pub. No.: US 2025/0091316 A1
(43) Pub. Date: Mar. 20, 2025

(54) Multilayer Sound Absorber, Method for Manufacturing a Multilayer Sound Absorber and Use of a Multilayer Sound Absorber

(71) Applicant: Sandler AG, Schwarzenbach (DE)

(72) Inventor: Stefan Herrmann, Doehlau (DE)

(21) Appl. No.: 18/887,853

(22) Filed: Sep. 17, 2024

(30) Foreign Application Priority Data
Sep. 20, 2023 (DE) 102023125511.8

(51) Int. Cl. B32B 5/26; B32B 5/02; B32B 37/18; G10K 11/168

(52) U.S. Cl. CPC B32B 5/269; B32B 5/022; B32B 37/18; G10K 11/168; B32B 2262/0284; B32B 2262/16; B32B 2305/18; B32B 2307/102; B32B 2307/554; B32B 2307/7376

(57) ABSTRACT

The invention relates to a multilayer sound absorber comprising a flow-resistant nonwoven with at least two individual flow-resistant layers, wherein the individual flow-resistant layers are arranged one above the other in a direction of penetration of the sound waves to be absorbed and each has a flow resistance between 300 Pa s/m and 1800 Pa s/m, preferably between 400 Pa s/m and 1500 Pa s/m, wherein the flow resistance of the respective individual flow-resistant layer increases from individual flow-resistant layer to individual flow-resistant layer in the direction of penetration. The invention also relates to a method for manufacturing the multilayer sound absorber according to the invention and to a use of the multilayer sound absorber according to the invention for sound absorption in the automotive sector, as well as in the field of building and room acoustics.

### CROSS-REFERENCE TO RELATED APPLICATION

This application claims the benefit of priority to German Patent Appl. No. 102023125511.8 filed Sep. 20, 2023, the disclosure of which is hereby incorporated by reference in its entirety.

### BACKGROUND

The invention relates to a multilayer sound absorber according to claim 1. In addition, the invention relates to a method for manufacturing a multilayer sound absorber according to claim 13 and to uses of the multilayer sound absorber according to claim 14 and claim 15.

For increasing the sound absorption of a multilayer sound absorber, increasing the thickness and increasing the flow resistance are known. In addition, as known from EP 3 375 923 A1, multilayer sound absorbers are known which have a layer of flow-resistant nonwoven with a high flow resistance next to another layer that provides advantageous sound absorption.

However, it has been shown that the known multilayer sound absorbers and the known ways of increasing sound absorption, especially for low frequencies between 400 and 1250 Hz, need to be improved for limited product thicknesses. Improved sound absorption in the low-frequency range is particularly important in the automotive industry, especially in the field of e-mobility, because tire rolling noise is in this low-frequency range and is not masked by the background noise of the combustion engine and manual or automatic transmission. In addition, the product thickness of the multilayer sound absorber is very limited in this field due to the restricted installation space.

Accordingly, the problem of the invention is to provide a multilayer sound absorber that, while taking into account a limited product thickness, enables improved sound absorption in the low frequency range between 400 and 1250 Hz.

### SUMMARY

The problem is solved by the features of independent claim 1. Accordingly, a solution to the problem according to the invention is present if the multilayer sound absorber comprises a flow-resistant nonwoven having at least two individual flow-resistant layers, wherein the individual flow-resistant layers are arranged one above the other in a direction of penetration of the sound waves to be absorbed and each has a flow resistance between 300 Pa s/m and 1800 Pa s/m, preferably between 400 Pa s/m and 1500 Pa s/m, wherein the flow resistance of the respective individual flow-resistant layer increases from individual flow-resistant layer to individual flow-resistant layer in the direction of penetration.

Surprisingly, due to the increasing flow resistance of the individual flow-resistant layers of the sound absorber's flow-resistant nonwoven in the direction of penetration, sound absorption in the low-frequency range can be significantly improved while maintaining the same overall product thickness.

At the same time, it has surprisingly been shown that even at very high frequency ranges, above 4000 Hz, an improvement in sound absorption occurs with the multilayer sound absorber according to the invention, while the overall product thickness remains the same.

Preferred embodiments of the present invention are the subject-matter of the sub-claims.

According to a particularly preferred embodiment of the present invention, the difference between the flow resistances of individual flow-resistant layers arranged directly above one another is between 300 and 1500 Pa s/m, preferably between 500 and 1000 Pa s/m. The sudden increase in flow resistance in the mentioned ranges results in particularly preferred sound absorption in the low-frequency range.

In another particularly preferred embodiment of the present invention, a first individual flow-resistant layer in the direction of penetration has a flow resistance of at least 400 Pa s/m, preferably a flow resistance between 400 and 700 Pa s/m, and a second individual flow-resistant layer directly adjacent to it in the direction of penetration has a flow resistance that is at least 400 Pa s/m higher, preferably between 500 and 1100 Pa s/m higher, and the flow resistance of the second individual flow-resistant layer is preferably between 900 and 1700 Pa s/m. A first individual flow-resistant layer and a second individual flow-resistant layer of this type enable a particularly advantageous sound absorption of the multilayer sound absorber.

According to another preferred embodiment, the individual flow-resistant layers have a weight per unit area of between 20 and 100 g/m², preferably between 35 and 85 g/m². This weight per unit area is preferred for achieving the necessary flow resistance of the individual flow-resistant layers and the desired thickness.

According to another preferred embodiment, the individual flow-resistant layers have a thickness between 0.1 and 1 mm, preferably between 0.3 and 0.6 mm. This enables a low overall thickness of the multilayer sound absorber and, at the same time, good sound absorption.

In another particularly preferred embodiment of the present invention, the individual flow-resistant layers are melt-blown nonwovens, wherein at least one of the individual flow-resistant layers is produced as a melt-blown nonwoven without a carrier and without a calender. In this way, the individual flow-resistant layers can be produced in a preferred manner. At the same time, this manufacturing process allows the high flow resistance of the individual flow-resistant layers to be set precisely. Preferably, the individual flow-resistant layers are produced with a spinning beam with 30 to 80 hpi, particularly preferably with 50 hpi. In this context, hpi is the unit “holes per inch”.

According to a particularly preferred embodiment, the flow-resistant nonwoven comprises two individual flow-resistant layers, wherein a first individual flow-resistant layer is configured as a melt-blown nonwoven having a weight per unit area of 40 g/m², a thickness between 0.43 and 0.47 mm and a flow resistance of 500 Pa s/m, and a second individual flow-resistant layer is configured as a melt-blown nonwoven with a weight per unit area of 80 g/m², a thickness between 0.53 and 0.57 mm and a flow resistance of 1500 Pa s/m. The flow-resistant nonwoven of this type enables improved sound absorption in the low-frequency range of the multilayer sound absorber.

According to another preferred embodiment, the flow-resistant nonwoven comprises a protective nonwoven against mechanical abrasion, which forms a first layer of the flow-resistant nonwoven in the direction of penetration and has a lower flow resistance than the individual flow-resistant layers. This allows the individual flow-resistant layers to be protected against mechanical abrasion without affecting the sound absorption of the multilayer sound absorber. Preferably, the protective nonwoven is a spunbonded nonwoven or a melt-blown nonwoven with full-surface calendering. These are two preferred manufacturing variants by which the protective nonwoven can be produced. Further preferably, the protective nonwoven is configured with a low flow resistance of less than 500 Pa s/m, particularly preferably less than 200 Pa s/m. The low flow resistance of the protective nonwoven allows the sound waves to pass through to the individual flow-resistant layers in the direction of penetration, where the particularly preferred sound absorption then takes place.

In another preferred embodiment, the flow-resistant nonwoven comprises at least three individual flow-resistant layers, wherein the difference between the flow resistances of adjacent individual flow-resistant layers decreases in the direction of penetration. The decrease in the difference between the flow resistances of adjacent individual flow-resistant layers in the direction of penetration is preferred.

According to a particularly preferred embodiment, the individual flow-resistant layers of the flow-resistant nonwoven are only connected to each other area-wise, so that cavities exist between the individual flow-resistant layers. It has been shown that the cavities between the individual flow-resistant layers can additionally improve sound absorption in the low-frequency range. Preferably, the individual flow-resistant layers are bonded by means of a calender having a pressing surface of 0.3 to 5%, more preferably of 0.4 to 3%, and more preferably of 0.6 to 1.2%, wherein the individual flow-resistant layers of the flow-resistant nonwoven are further preferably bonded by the calender at spaced-apart engraved points which form a pattern. This allows cavities to be formed to an extent that enables additional improvement of sound absorption.

According to another preferred embodiment, the protective nonwoven and the individual flow-resistant layers of the flow-resistant nonwoven are only connected to each other area-wise, so that cavities exist between the protective nonwoven and the individual flow-resistant layers and between the individual flow-resistant layers. It has been shown that the cavities can further improve sound absorption in the low-frequency range. Preferably, the protective nonwoven and the individual flow-resistant layers are bonded by means of a calender having a pressing surface of 0.3 to 5%, more preferably of 0.4 to 3%, and yet more preferably of 0.6 to 1.2%, wherein the protective nonwoven and the individual flow-resistant layers of the flow-resistant nonwoven are further preferably bonded by the calender at spaced-apart engraved points that form a pattern. This makes it possible to form cavities to an extent that allows for an additional improvement in sound absorption.

Preferably, the engraved points, produced by the calender, form a rhomboid pattern, square pattern, circle pattern or polygon pattern in the two embodiments described above, wherein the rhomboid pattern is particularly preferred. Further preferably, the engraved points have a diameter between 0.5 and 3 mm, preferably between 1.4 and 2.4 mm, and/or have a minimum distance between them of 5 to 20 mm, preferably between 8 and 15 mm.

In a further preferred embodiment, the multilayer sound absorber has a carrier nonwoven in addition to the flow-resistant nonwoven, wherein the carrier nonwoven is laminated in the direction of penetration onto a rear side of the flow-resistant nonwoven and comprises at least first fibers having a titer of 3 to 28 dtex and second fibers having a titer of 0.5 to 3 dtex. Preferably, the carrier nonwoven consists of a fiber blend of fibers with 0.5 dtex to 28 dtex. Such a carrier nonwoven, in combination with the flow-resistant nonwoven, enables particularly good sound absorption in the low-frequency range while maintaining a low product thickness.

According to a preferred embodiment, the carrier nonwoven is thermally consolidated and/or mechanically consolidated and/or has a weight per unit area between 200 and 1200 g/m², preferably between 200 and 600 g/m². The properties of such carrier nonwovens, in combination with the flow-resistant nonwoven, have a positive effect on the properties of the multilayer sound absorber.

Preferably, the carrier nonwoven has a thickness of 4 to 50 mm, preferably of 8 to 35 mm, more preferably of 8 to 25 mm. A multilayer sound absorber of this type, having a carrier nonwoven of this type in combination with the flow-resistant nonwoven, has preferred sound absorption in the low-frequency range and, at the same time, has a thickness such that the multilayer sound absorber can be used advantageously in limited installation spaces.

According to a preferred embodiment, the multilayer sound absorber consists of only one starting material, preferably PET or PBT. Such material purity is preferred for reasons of recyclability and ease of disposal.

In a further particularly preferred embodiment, the multilayer sound absorber has an overall thickness between 5 and 50 mm, preferably between 8 and 35 mm, particularly preferably between 10 and 25 mm. Such a multilayer sound absorber is particularly suitable for limited installation space, especially in the automotive sector, and also allows preferred sound absorption in the low frequency range when the usable installation space is small.

In addition, the invention also relates to a method for manufacturing a multilayer sound absorber according to one of the embodiments described above, wherein the individual flow-resistant layers of the flow-resistant nonwoven are arranged one above the other in the direction of penetration after their manufacture. In this way, a preferred multilayer sound absorber can be manufactured.

According to a preferred embodiment of the method according to the invention, the individual flow-resistant layers of the flow-resistant nonwoven are bonded to one another only area-wise, so that cavities result between the individual flow-resistant layers. Preferably, the individual flow-resistant layers are bonded by means of a calender which has a pressing surface of 0.3 to 10%, more preferably of 0.4 to 5%, and yet more preferably of 0.6 to 1.2%, wherein the calender is more preferably a rhomboid calender. The protective nonwoven is also particularly preferably bonded to the individual flow-resistant layers of the flow-resistant nonwoven in the same area-wise manner in the same work step.

In another preferred embodiment of the method according to the invention, the individual flow-resistant layers of the flow-resistant nonwoven are produced as a melt-blown nonwoven without a carrier and without a calender. Preferably, the individual flow-resistant layers are produced with a spinning beam with 30 to 80 hpi. In this way, individual flow-resistant layers with corresponding flow resistances can be produced in a preferred manner.

According to a further preferred embodiment, the carrier nonwoven is produced parallel to the flow-resistant nonwoven, wherein the carrier nonwoven is preferably thermally consolidated and not needled. According to a further preferred embodiment, the carrier nonwoven is laminated unilaterally onto the flow-resistant nonwoven as the last step in the manufacturing process. Preferably, an adhesive nonwoven made of the same starting material as the flow-resistant nonwoven and the carrier nonwoven is used as the adhesion promoter.

In addition, the invention is also directed to the use of a multilayer sound absorber according to one of the above-described embodiments for sound absorption in the automotive sector. Due to the excellent sound absorption in the low-frequency range and the small thickness of the multilayer sound absorber required for this, it is excellently suitable for sound absorption in the automotive sector. Particularly preferred, the multilayer sound absorber according to the invention is used for the field of electric mobility. In this field, tire rolling noise plays a prominent role in vehicle acoustics in the interior, since the masking background noise of the combustion engine and the manual or automatic transmission is absent. These rolling noises are particularly in the low-frequency range, so that the advantageous properties of the multilayer sound absorber according to the invention are particularly prominent.

In addition, the invention is directed to the use of a multilayer sound absorber according to one of the embodiments described above for soundproofing in the field of building and room acoustics. In this context, improved sound absorption in the high-frequency range above 4000 Hz is preferred.

Embodiments of the present invention will be explained in more detail below with reference to drawings.

### BRIEF DESCRIPTION OF THE DRAWINGS

FIG. 1 depicts a schematic cross-sectional view of a first embodiment of a multilayer sound absorber according to the invention,

FIG. 2 depicts a schematic production line for a flow-resistant nonwoven of the first embodiment of a multilayer sound absorber according to the invention,

FIG. 3 depicts a schematic view in the direction of penetration of the first layer of the first embodiment of a multilayer sound absorber according to the invention,

FIG. 4 shows a comparison of the absorption coefficient measured in an α cabin (ISO 354:2003) of an embodiment A2 according to the invention with comparative examples V1 and V2,

FIG. 5 shows a comparison of the absorption coefficient measured in an α cabin (ISO 354:2003) of the embodiments A3, A4 and A5 according to the invention with the comparative examples V3 and V4, and

FIG. 6 shows a comparison of the absorption coefficient measured in an α cabin (ISO 354:2003) of the embodiment A6 according to the invention with the comparative example V5.

### DETAILED DESCRIPTION

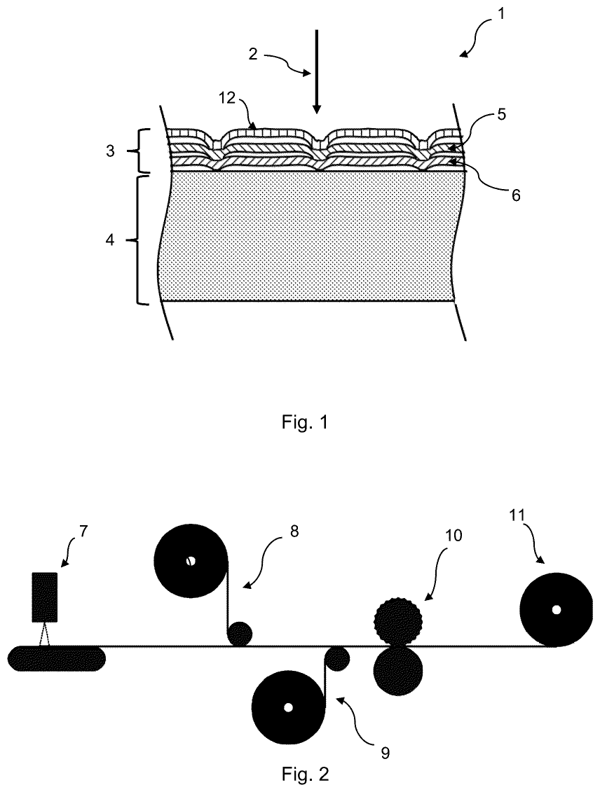

FIG. 1 shows a schematic cross-sectional view of a first embodiment of a multilayer sound absorber 1 according to the invention, wherein the sectional plane is aligned parallel to a direction of penetration 2 of the sound waves to be absorbed by the multilayer sound absorber 1. The cross-sectional view is only schematic. Thus, the thicknesses of the individual layers are not shown to scale. The first embodiment of the multilayer sound absorber according to the invention consists of a flow-resistant nonwoven 3, which is arranged in front of a carrier nonwoven 4 in the direction of penetration 2.

In this embodiment, the carrier nonwoven 4 is formed as a fiber nonwoven from a fiber blend consisting of 40% Co-PET fibers with a fiber titer of 4 den and a length of 51 mm and of 60% PET fibers with a fiber denier of 0.9 dtex and a length of 31 mm, with a weight per unit area of 400 g/m² and a thickness of 30 mm, wherein the carrier nonwoven is thermally consolidated and not needled.

In this case, the flow-resistant nonwoven 3 consists of three layers arranged one above the other. In this context, the first layer in the direction of penetration 2 is a protective nonwoven 12, according to the first embodiment, which protects the multilayer sound absorber 1 from mechanical abrasion and, in this embodiment, is produced as a PET spunbonded nonwoven with a weight per unit area of 19 g/m². The layer adjacent to the protective nonwoven 12 in penetration direction 2 is a first individual flow-resistant layer 5, which, in accordance with this embodiment, is a PET melt-blown nonwoven with a weight per unit area of 40 g/m², a flow resistance of 500 Pa s/m and a thickness between 0.43 and 0.57 mm. A second individual flow-resistant layer 6 adjoins the first individual flow-resistant layer 5 in the direction of penetration 2, which, in accordance with this embodiment, is a PET melt-blown nonwoven with a weight per unit area of 80 g/m², a flow resistance of 1500 Pa s/m and a thickness between 0.53 and 0.57 mm. The three layers of the flow-resistant nonwoven 3 are bonded in certain areas by means of a rhomboid calender with a pressing surface of 0.9%, so that cavities are formed between the individual layers of the flow-resistant nonwoven 3. With the flow-resistant nonwoven 3 formed in such a way, the flow resistance increases stepwise from layer to layer. In combination with the cavities between the layers of the flow-resistant nonwoven 3 and with the carrier nonwoven 4, to which the flow-resistant nonwoven 3 is unilaterally laminated, this leads to a particularly advantageous sound absorption in the low frequency range between 400 and 1250 Hz.

FIG. 2 shows a schematic production line for a flow-resistant nonwoven 3 according to the first embodiment shown in FIG. 1. According to this production line, the first individual flow-resistant layer 5 is produced by the melt-blown technique on a spinning beam 7 at 50 hpi. The protective nonwoven 4 is then placed on this first individual flow-resistant layer 5 in a first unwinding station 8 and then the second individual flow-resistant layer 6 is placed on top in a second unwinding station 9. The three layers arranged in this way are then bonded to one another in a rhomboid calender 10 with a pressing surface of 0.9% in certain areas and wound up by means of a winder 11. The flow-resistant nonwoven 3 produced in such a way can then be laminated on one side onto the carrier nonwoven 4 in a downstream step. In this case, for example, a Co-PET adhesive nonwoven can be used as an adhesion promoter.

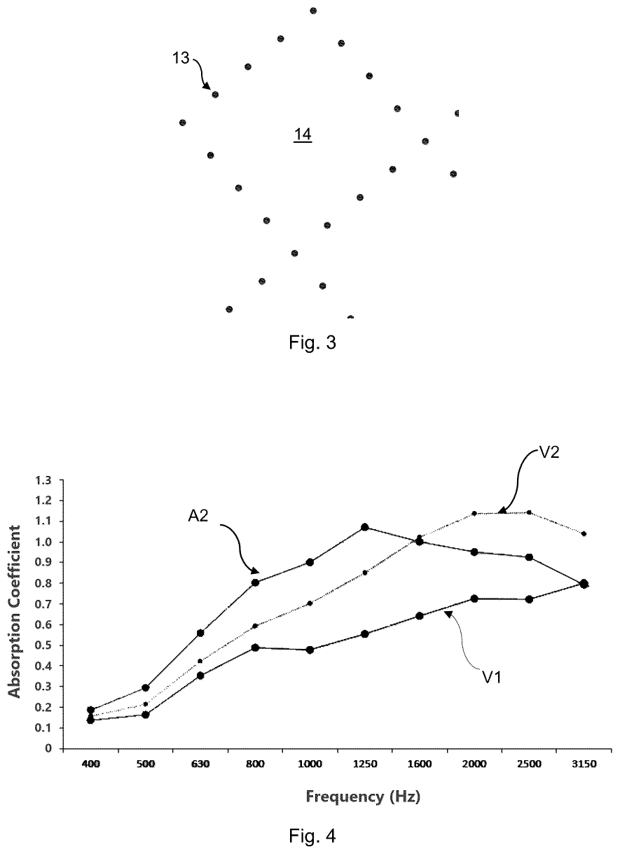

FIG. 3 shows a schematic top view in penetration direction 2 of the flow-resistant nonwoven 3 according to the first embodiment, shown in FIG. 1, and thus of the protective nonwoven 12. This is bonded to the first individual flow-resistant layer 5 and the second individual flow-resistant layer 6 by means of a rhomboid calender 10. The rhomboid calender 10 forms engraved points 13 in a rhomboid pattern. These engraved points 13 are spaced apart and form large non-bonded areas 14 due to the rhomboid pattern. The large non-bonded areas 14 allow the layers of the flow-resistant nonwoven 3 to vibrate.

FIG. 4 shows a comparison of the absorption coefficient over a frequency range between 400 and 3150 Hz, measured in an α-cabin based on ISO 354:2003, of an embodiment A2 according to the invention comprising a carrier nonwoven, with a comparative example V1 comprising only a carrier nonwoven, and with a comparative example V2 comprising a carrier nonwoven and a single individual flow-resistant layer.

### Embodiment A2

The multilayer sound absorber according to embodiment A2 consists of a three-layer flow-resistant nonwoven and a carrier nonwoven. In the direction of penetration, the flow-resistant nonwoven consists of a first individual flow-resistant layer made of a melt-blown nonwoven with a weight per unit area of 40 g/m², a flow resistance of 500 Pa s/m and a thickness of 0.32 mm, a second individual flow-resistant layer made of PBT melt-blown nonwoven with a weight per unit area of 40 g/m², a flow resistance of 1064 Pa s/m and a thickness of 0.34 mm, and a third individual flow-resistant layer made of a PBT melt-blown nonwoven with a weight per unit area of 60 g/m², a flow resistance of 1389 Pa s/m and a thickness of 0.33 mm. The carrier nonwoven consists of a fiber nonwoven made of 55% PET-Biko 3 den/51 mm and 45% PET 0.9 den/38 mm with a weight per unit area of 250 g/m². The multilayer sound absorber according to embodiment A2 has an overall thickness of 15 mm.

### Comparative Example V1

The comparative example V1 consists of a fiber nonwoven made of 55% PET-Biko 3 den/51 mm and 45% PET 0.9 den/38 mm with a weight per unit area of 250 g/m² and also has an overall thickness of 15 mm.

### Comparative Example V2

In the direction of penetration, the comparative example V2 consists of a single-layer flow-resistant nonwoven made of a PBT melt-blown nonwoven with a weight per unit area of 60 g/m², a flow resistance of 1389 Pa s/m and a thickness of 0.33 mm and a carrier nonwoven made of a fiber nonwoven of 55% PET-Biko 3 den/51 mm and 45% PET 0.9 den/38 mm with a weight per unit area of 250 g/m² and also has an overall thickness of 15 mm.

The comparison clearly shows the increased sound absorption of embodiment A2 according to the invention compared to the comparative examples V1 and V2 in the low frequency range between 400 and 1250 Hz. In this case, the thickness of the three compared examples is the same. Accordingly, embodiment A2 according to the invention is preferable for use as a sound absorber in the low frequency range compared to the comparative examples V1 and V2.

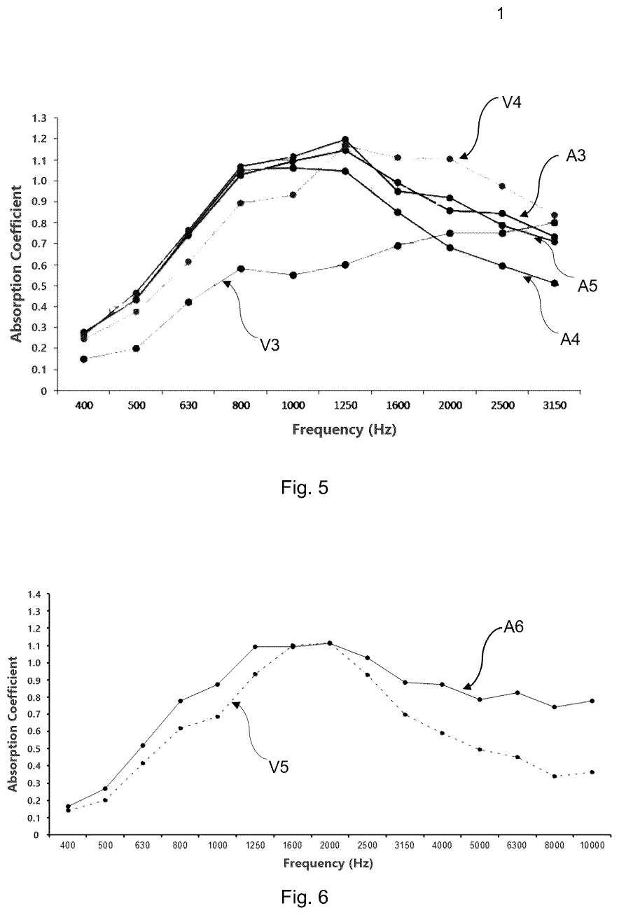

FIG. 5 shows a comparison of the absorption coefficient over a frequency range between 400 and 3150 Hz measured in an α-cabin based on ISO 354:2003 of three embodiments A3, A4 and A5 according to the invention with comparative embodiments V3 and V4.

### Embodiment A3

The multilayer sound absorber according to embodiment A3 consists of a three-layer flow-resistant nonwoven and a carrier nonwoven. In the direction of penetration, the flow-resistant nonwoven consists of a first individual flow-resistant layer made of a melt-blown nonwoven with a weight per unit area of 40 g/m², a flow resistance of 500 Pa s/m and a thickness of 0.32 mm, a second individual flow-resistant layer made of a PET melt-blown nonwoven with a weight per unit area of 40 g/m², a flow resistance of 1064 Pa s/m and a thickness of 0.34 mm, and a third individual flow-resistant layer made of a PET melt-blown nonwoven with a weight per unit area of 60 g/m², a flow resistance of 1389 Pa s/m and a thickness of 0.33 mm. The carrier nonwoven consists of a fiber nonwoven made of 20% PET 1.3 dtex/38 mm, 25% PET-Biko 4 den/51 mm and 55% PET 1.5 den/38 mm with a weight per unit area of 300 g/m². The multilayer sound absorber according to embodiment A3 has an overall thickness of 15 mm.

### Embodiment A4

The multilayer sound absorber according to embodiment A4 consists of a three-layer flow-resistant nonwoven and a carrier nonwoven. In the direction of penetration, the flow-resistant nonwoven consists of a first individual flow-resistant layer made of a PET melt-blown nonwoven with a weight per unit area of 40 g/m², a flow resistance of 1064 Pa s/m and a thickness of 0.34 mm, a second individual flow-resistant layer made of a PET melt-blown nonwoven with a weight per unit area of 40 g/m², a flow resistance of 2272 Pa s/m and a thickness of 0.14 mm, and a third individual flow-resistant layer made of a PET melt-blown nonwoven with a weight per unit area of 60 g/m², a flow resistance of 3125 Pa s/m and a thickness of 0.20 mm. The carrier nonwoven consists of a fiber nonwoven made of 20% PET 1.3 dtex/38 mm, 25% PET-Biko 4 den/51 mm and 55% PET 1.5 den/38 mm with a weight per unit area of 300 g/m². The multilayer sound absorber according to embodiment A4 has an overall thickness of 15 mm.

### Embodiment A5

The multilayer sound absorber according to embodiment A5 consists of a three-layer flow-resistant nonwoven and a carrier nonwoven. In the direction of penetration, the flow-resistant nonwoven consists of a first individual flow-resistant layer made of a melt-blown nonwoven with a weight per unit area of 40 g/m², a flow resistance of 500 Pa s/m and a thickness of 0.32 mm, a second individual flow-resistant layer made of a PET melt-blown nonwoven with a weight per unit area of 40 g/m², a flow resistance of 1064 Pa s/m, a thickness of 0.34 mm, and a third individual flow-resistant layer made of a PET melt-blown nonwoven with a weight per unit area of 60 g/m², a flow resistance of 1389 Pa s/m and a thickness of 0.33 mm. The carrier nonwoven consists of a fiber nonwoven made of 40% PET-Biko 4.4 dtex/51 mm and 60% PET 0.9 dtex/38 mm with a weight per unit area of 300 g/m². The multilayer sound absorber according to embodiment A5 has an overall thickness of 15 mm.

### Comparative Example V3

The comparative example V3 consists of a fiber nonwoven made of 20% PET 1.3 dtex/38 mm, 25% PET-Biko 4 den/51 mm and 55% PET 1.5 den/38 mm with a weight per unit area of 300 g/m² and also has an overall thickness of 15 mm.

### Comparative Example V4

In the direction of penetration, the comparative example V4 consists of a single-layer flow-resistant nonwoven made of a PET melt-blown nonwoven with a weight per unit area of 80 g/m², a flow resistance of 1550 Pa s/m and a thickness of 0.56 mm, and a carrier nonwoven made of 20% PET 1.3 dtex/38 mm, 25% PET-Biko 4 den/51 mm and 55% PET 1.5 den/38 mm with a weight per unit area of 300 g/m² and also has an overall thickness of 15 mm.

The comparison shown in FIG. 5 also shows the increased sound absorption of the embodiments according to the invention A3, A4 and A5 compared to the comparative examples V3 and V4 in the low frequency range between 400 and 1250 Hz.

FIG. 6 shows a comparison of the absorption coefficient over a frequency range between 400 and 10,000 Hz, measured in an α-cabin based on ISO 354:2003, of an embodiment A6 according to the invention with a comparative example V6, which comprises a carrier nonwoven and a single individual flow-resistant layer.

### Embodiment A6

The multilayer sound absorber according to embodiment A6 consists of a three-layer flow-resistant nonwoven and a carrier nonwoven. In the direction of penetration, the flow-resistant nonwoven consists of a protective nonwoven in the form of a spunbonded nonwoven with a weight per unit area of 19 g/m², a flow resistance of <200 Pa s/m and a thickness of 0.10 mm, a first individual flow-resistant layer PBT melt-blown nonwoven with a weight per unit area of 40 g/m², a flow resistance of 500 Pa s/m and a thickness of 0.45 mm, and a second individual flow-resistant layer made of a PBT melt-blown nonwoven with a weight per unit area of 80 g/m², a flow resistance of 1500 Pa s/m and a thickness of 0.56 mm. The carrier nonwoven consists of a fiber nonwoven made of 70% PET-Biko 4 den/51 mm, 20% PET 12 den/64 mm and 10% PET 11 dtex/60 mm hollow fiber with a weight per unit area of 1000 g/m² and a flow resistance of 256 Pa s/m. The multilayer sound absorber according to embodiment A6 has an overall thickness of 12 mm.

### Comparative Example V5

In the direction of penetration, the comparative example V5 consists of a single-layer flow-resistant nonwoven made of a PBT melt-blown nonwoven with a weight per unit area of 80 g/m², a flow resistance of 5350 Pa s/m and a thickness of 0.22 mm, and a carrier nonwoven made of a fiber nonwoven of 70% PET-Biko 4 den/51 mm, 20% PET 12 den/64 mm and 10% PET 11 dtex/60 mm hollow fiber with a weight per unit area of 1000 g/m² and an airflow resistance of 256 Pa s/m and also has an overall thickness of 12 mm.

The comparison clearly shows the increased sound absorption of embodiment A6 according to the invention compared to comparative embodiment V5 in the low frequency range between 400 and 1250 Hz. At the same time, however, the comparison also shows the significantly increased sound absorption of embodiment A6 according to the invention compared to comparative embodiment V5 in the very high frequency range between 4000 and 10000 Hz. The thickness of the compared embodiments is the same. Accordingly, embodiment A6 according to the invention is preferable to comparative embodiment V5 for use as a sound absorber in the low frequency range and very high frequency range.

### LIST OF REFERENCE SIGNS

1 multilayer sound absorber
2 direction of penetration
3 flow-resistant nonwoven
4 carrier nonwoven
5 first individual flow-resistant layer
6 second individual flow-resistant layer
7 spinning beam
8 first unwinding station
9 second unwinding station
10 rhomboid calender
11 winder
12 protective nonwoven
13 engraved points
14 unbonded areas
A2 second embodiment
A3 third embodiment
A4 fourth embodiment
A5 fifth embodiment
V1 first comparative example
V2 second comparative example
V3 third comparative example
V4 fourth comparative example

1. A multilayer sound absorber comprising a flow-resistant nonwoven with at least two individual flow-resistant layers, wherein the individual flow-resistant layers are arranged one above the other in a direction of penetration of the sound waves to be absorbed and each has a flow resistance between 300 Pa s/m and 1800 00 Pa s/m, preferably between 400 Pa s/m and 1500 Pa s/m, and wherein the flow resistance of the respective individual flow-resistant layer increases from individual flow-resistant layer to individual flow-resistant layer in the direction of penetration.

2. The multilayer sound absorber according to claim 1, a difference between the flow resistances of individual flow-resistant layers arranged directly one above the other is between 300 and 1500 Pa s/m, preferably between 500 and 1000 Pa s/m.

3. The multilayer sound absorber according to claim 1, wherein a first individual flow-resistant layer in the direction of penetration has a flow resistance of at least 400 Pa s/m, preferably a flow resistance between 400 and 700 Pa s/m, and a second individual flow-resistant layer directly adjacent to it in the direction of penetration has a flow resistance that is at least 400 Pa s/m higher, preferably a flow resistance that is between 500 and 1100 Pa s/m higher, and wherein the flow resistance of the second individual flow-resistant layer is preferably between 900 and 1700 Pa s/m.

4. The multilayer sound absorber according to claim 1, wherein the individual flow-resistant layers have a weight per unit area between 20 and 100 g/m², preferably between 35 and 85 g/m², and/or the individual flow-resistant layers have a thickness between 0.1 and 1 mm, preferably between 0.3 and 0.7 mm.

5. The multilayer sound absorber according to claim 1, wherein the individual flow-resistant layers are melt-blown nonwovens, wherein at least one of the individual flow-resistant layers is produced as a melt-blown nonwoven without a carrier and without a calender, and wherein the individual flow-resistant layers are preferably produced with a spinning beam with 30 to 80 hpi, particularly preferably with 50 hpi.

6. The multilayer sound absorber according to claim 1, wherein the flow-resistant nonwoven comprises a protective nonwoven against mechanical abrasion which forms a first layer of the flow-resistant nonwoven in the direction of penetration and has a lower flow resistance than the individual flow-resistant layers, and wherein the protective nonwoven is preferably a spunbonded nonwoven or a melt-blown nonwoven with full-surface calendering and is further preferably formed with a low flow resistance of below 500 Pa s/m, particularly preferably below 200 Pa s/m.

7. The multilayer sound absorber according to claim 1, wherein the flow-resistant nonwoven comprises at least three individual flow-resistant layers, and wherein the difference between the flow resistances of mutually adjacent individual flow-resistant layers decreases in the direction of penetration.

8. The multilayer sound absorber according to claim 1, wherein the individual flow-resistant layers of the flow-resistant nonwoven are bonded to one another only area-wise, so that cavities remain between the individual flow-resistant layers, wherein the individual flow-resistant layers are preferably bonded by means of a calender having a pressing surface of 0.3 to 5%, more preferably of 0.4 to 3%, and more preferably of 0.6 to 1.2%, and wherein the individual flow-resistant layers of the flow-resistant nonwoven are bonded by the calender, preferably at spaced-apart engraved points that form a pattern.

9. The multilayer sound absorber according to claim 1, wherein the multilayer sound absorber has a carrier nonwoven in addition to the flow-resistant nonwoven, and wherein the carrier nonwoven is laminated in the direction of penetration on a rear side of the flow-resistant nonwoven and comprises at least first fibers having a titer of 3 to 28 dtex and second fibers having a titer of 0.5 to 3 dtex.

10. The multilayer sound absorber according to claim 9, wherein the carrier nonwoven is thermally consolidated and/or mechanically consolidated and/or has a weight per unit area between 200 and 1200 g/m², preferably between 200 and 600 g/m².

11. The multilayer sound absorber according to claim 1, wherein the multilayer sound absorber consists of only one starting material, preferably of PET or PBT.

12. The multilayer sound absorber according to claim 1, wherein the multilayer sound absorber has an overall thickness between 5 and 50 mm, preferably between 8 and 35 mm, particularly preferably between 10 and 25 mm.

13. A method for manufacturing a multilayer sound absorber according to claim 1, wherein the individual flow-resistant layers of the flow-resistant nonwoven are arranged one above the other in the direction of penetration after their manufacture and are bonded to one another only area-wise in such a way that cavities remain between the individual flow-resistant layers.

14. The use of a multilayer sound absorber according to claim 1 for sound absorption in the automotive sector.

15. The use of a multilayer sound absorber according to claim 1 for soundproofing in the field of building and room acoustics.
